(19) United States
(12) Patent Application Publication
(10) Pub. No.: US 2017/0101320 A1
(43) Pub. Date: Apr. 13, 2017

(54) PROCESS FOR THE PREPARATION OF PURE OCTACHLOROTRISILANES AND DECACHLOROTETRASILANES

(71) Applicants: Janaina MARINAS PEREZ, Murg (DE); Hartwig RAULEDER, Rheinfelden (DE); Juergen Erwin LANG, Karlsruhe (DE); Christian GOETZ, Taipei (TW); Goswin UEHLENBRUCK, Oberursel (DE)

(72) Inventors: Janaina MARINAS PEREZ, Murg (DE); Hartwig RAULEDER, Rheinfelden (DE); Juergen Erwin LANG, Karlsruhe (DE); Christian GOETZ, Taipei (TW); Goswin UEHLENBRUCK, Oberursel (DE)

(73) Assignee: EVONIK DEGUSSA GmbH, Essen (DE)

(21) Appl. No.: 15/123,161

(22) PCT Filed: Feb. 3, 2015
(86) PCT No.: PCT/EP2015/052120

§ 371 Date: Sep. 1, 2016

(30) Foreign Application Priority Data
Mar. 3, 2014 (DE) 102014203810.3

(51) Int. Cl. C01B 33/107; B01D 3/10; B01J 19/02; C01G 17/04; B01J 19/08

(52) U.S. Cl. CPC C01B 33/10778; C01B 33/107; C01G 17/04; B01J 19/088; B01J 19/02; B01D 3/10; B01J 2219/0896; B01J 2219/0254

(57) ABSTRACT

The invention relates to a process for producing trimeric and/or quaternary silicon compounds or trimeric and/or quaternary germanium compounds, where a mixture of silicon compounds or a mixture of germanium compounds is exposed to a nonthermal plasma, and the resulting phase is subjected at least once to a vacuum rectification and filtration.

The invention relates to a process and to an apparatus for producing high-purity and ultrahigh-purity octachlorotrisilane and decachlorotetrasilane from chlorosilanes by exposing monomeric chlorosilane to a nonthermal plasma and vacuum distilling the resulting phase.

The prior art discloses processes for preparing polychlorosilanes. For example, DE 10 2006 034 061 discloses a reaction of silicon tetrachloride with hydrogen for preparing polysilanes. Because of the reaction in the presence of hydrogen, the polysilanes prepared contain hydrogen. In order to be able to keep the plant in continuous operation, tetrachlorosilane is added in excess in relation to the hydrogen. In addition, the plant disclosed has a complex structure and allows only the preparation of polysilane mixtures. An elevated molecular weight of the polysilanes can be achieved only through series connection of a plurality of reactors and high-frequency generators. After passing through each of the series-connected plasma reactors, there is an increase in the molecular weight of the polysilanes after each plasma reactor. The process disclosed is restricted to the preparation of compounds which can be converted to the gas phase without decomposition.

EP 1 264 798 A1 discloses a process for working up by-products comprising hexachlorodisilane during the preparation of polycrystalline silicon.

U.S. Pat. No. 4,542,002 and WO 2009/143823 A2 also disclose plasma-chemical processes for preparing polychlorosilanes starting from silicon tetrachloride and hydrogen. As a result of the preparation, hydrogen-containing polychlorosilanes are obtained. According to WO 2009/143823 A2, mixtures of hydrogen-containing high molecular weight polychlorosilanes are obtained. The silicon tetrachloride present in the polychlorosilanes must be removed by distillation in vacuum prior to further use, thus entailing complexity. A particular disadvantage in the prior art is the need to prepare the polychlorosilanes in the presence of gaseous hydrogen. As a result, very high safety demands are placed on the materials and the safeguarding of the plant.

Accordingly, it is customary in the prior art to carry out conversion reactions in plasmas to generate complex mixtures in which the actually desired product arises together with numerous by-products, and/or together with by-products which mimic very closely the desired one in terms of its structure.

It was an object of the present invention to make trimeric or quaternary chlorosilanes or trimeric or quaternary chlorogermanium compounds industrially useful. It is also an object of the present invention to provide an economical process for the gentle isolation of the trimeric or quaternary chlorosilanes.

Surprisingly, it has been found that a mixture of silicon compounds of the general formula Siₙ(R₁ . . . R₂ₙ₊₂), which has for example silicon tetrachloride, or a mixture of germanium compounds of the general formula Geₙ(R₁ . . . R₂ₙ₊₂) with n at least 2, and R₁ to R₂ₙ₊₂ are hydrogen and/or X=chlorine, bromine and/or iodine, are converted in a nonthermal plasma to a mixture of silicon compounds of the general formula Si₃X₈ or Si₄X₁₀ or germanium compounds of the general formula Ge₃X₈ or Ge₄X₁₀, as well as further polycompounds of silicon or germanium.

These polycompounds have at least two silicon or germanium atoms. Contemplated as such are in particular dodecachloropentasilane and structural isomers thereof or compounds of germanium. It was likewise surprising that such a preparation is possible essentially without the presence of hydrogen gas in the nonthermal plasma.

Furthermore, it was surprisingly found that a trimeric or quaternary silicon or germanium compound obtained in a nonthermal plasma, which on account of the processes in a plasma is usually to be expected together with numerous other compounds, is obtained in high-purity after at least one vacuum rectification of the resulting phase.

The invention therefore provides a process for the preparation of trimeric and/or quaternary silicon compounds of the general formula Si₃X₈ and/or Si₄X₁₀ or of trimeric and/or quaternary germanium compounds of the general formula Ge₃X₈ and/or Ge₄X₁₀,
a) where a mixture of silicon compounds of the general formula

Siₙ(R₁ . . . R₂ₙ₊₂)

or a mixture of germanium compounds of the general formula

Geₙ(R₁ . . . R₂ₙ₊₂)
with n≧2, and R₁ to R₂ₙ₊₂ are hydrogen and/or X and X=halogen, and
   the halogen is selected from chlorine, bromine and/or iodine, is exposed to a nonthermal plasma, and
b) the resulting phase is subjected at least once to a vacuum rectification and filtration,

where silicon compounds of the general formula Si₃X₈ or Si₄X₁₀ or germanium compounds of the general formula Ge₃X₈ or Ge₄X₁₀ are obtained.

In the context of the invention, the expression “silicon compounds of the general formula Si₃X₈ or Si₄X₁₀ or germanium compounds of the general formula Ge₃X₈ or Ge₄X₁₀” is abbreviated to “product”, and the mixture of silicon compounds of the general formula Siₙ(R₁ . . . R₂ₙ₊₂) or of germanium compounds of the general formula Geₙ(R₁ . . . R₂ₙ₊₂) used in step a is abbreviated to “starting material”.

The economic advantage of the process according to the invention is achieved in particular by the apparatus according to the invention with a gas discharge reactor which is arranged between two columns.

The resulting product is preferably free from hydrogen. In the context of the invention free from hydrogen applies if the content of hydrogen atoms is below 1×10⁻³% by weight, preferably below 1×10⁻⁴% by weight, further preferably below 1×10⁻⁶% by weight up to the detection limit at currently 1×10⁻¹% by weight.

The preferred method for determining the content of hydrogen atoms is ¹H-NMR spectroscopy. To determine the overall contamination profile with other elements specified below, ICP-MS is used.

A particularly major advantage of the process according to the invention is the direct usability of the resulting product without further purification for the deposition of high-purity silicon or germanium layers with solar technology of suitable quality or semiconductor quality.

The invention therefore likewise provides the use of the product prepared according to the invention for producing silicon nitride, silicon oxynitride, silicon carbide, silicon oxycarbide or silicon oxide, or germanium nitride, germanium oxynitride, germanium carbide, germanium oxycarbide or germanium oxide.

The process according to the invention is explained in more detail below.

In step a of the process, the reaction takes place in a nonthermal plasma. It may be advantageous to use a gas discharge reactor and a column arranged downstream.

Preferably, starting material where n≧3 can be used in the process according to the invention.

Preferably, in the process according to the invention, starting material is used which has a total contamination with elements specified below of less than or equal to 100 ppm by weight to 0.001 ppt by weight. A total contamination with the elements below of less than or equal to 50 ppm by weight to 0.001 ppt by weight defines a ultrahigh-purity starting material, with less than or equal to 40 ppm by weight to 0.001 ppt by weight of overall impurity being preferred. Furthermore preferably, the content of overall contaminants is less than or equal to 100 ppm by weight to 0.001 ppt by weight, particularly preferably less than or equal to 50 ppm by weight to 0.001 ppt by weight, where the contaminant profile of the starting material is as follows:

a. aluminium from 15 ppm by weight to 0.0001 ppt by weight, and/or

b. boron less than or equal to 5 to 0.0001 ppt by weight, preferably in the range from 3 ppm by weight to 0.0001 ppt by weight, and/or

c. calcium less than or equal to 2 ppm by weight, preferably from 2 ppm by weight to 0.0001 ppt by weight, and/or

d. iron from 5 ppm by weight to 0.0001 ppt by weight, preferably from 0.6 ppm by weight to 0.0001 ppt by weight, and/or

e. nickel from 5 ppm by weight to 0.0001 ppt by weight, preferably from 0.5 ppm by weight to 0.0001 ppt by weight, and/or

f. phosphorus from 5 ppm by weight to 0.0001 ppt by weight, preferably from 3 ppm by weight to 0.0001 ppt by weight, and/or

g. titanium less than or equal to 10 ppm by weight, less than or equal to 2 ppm by weight, preferably from 1 ppm by weight to 0.0001 ppt by weight, further preferably from 0.6 ppm by weight to 0.0001 ppt by weight, further preferably from 0.1 ppm by weight to 0.0001 ppt by weight, and/or

h. zinc less than or equal to 3 ppm by weight, preferably from 1 ppm by weight to 0.0001 ppt by weight, further preferably from 0.3 ppm by weight to 0.0001 ppt by weight, and/or

i. carbon,
where the target concentration of carbon is at a detection limit customary in the context of the measurement method known to a person skilled in the art.

The total contamination with the aforementioned elements is preferably determined by means of ICP-MS. Overall, the process can be monitored continuously by means of online analysis. The required purity can be checked by means of GC, IR, NMR, ICP-MS, or by resistance measurement or GD-MS after deposition of the Si.

It is likewise advantageous that it is possible to dispense with the use of costly, inert noble gases. Alternatively, it is possible to add an entraining gas, preferably a pressurized inert gas, such as nitrogen, argon, another noble gas or mixtures thereof.

A further advantage of the process is the selective preparation of ultrahigh-purity octachlorotrisilane which may have a low content of ultrahigh-purity hexachlorodisilane, ultrahigh-purity decachlorotetrasilanes and/or dodecachloropentasilane and meets the demands of the semiconductor industry in an excellent manner.

In the process according to the invention, the product can be obtained in a purity in the ppb range.

According to the process, as well as octachlorotrisilane and/or decachlorotetrasilane, additionally hexachlorodisilane, dodecachloropentasilane or a mixture comprising at least two of the specified polychlorosilanes can additionally be obtained.

In the process according to the invention, “high-purity” and “ultrahigh-purity” product can be obtained, which is defined as follows.

The high-purity product has a content of total contamination of less than or equal to 100 ppm by weight, and the ultrahigh-purity product less than or equal to 50 ppm by weight of total contamination.

The total contamination is the sum of the contaminations with one, more or all elements selected from boron, phosphorus, carbon and foreign metals, as well as hydrogen, preferably selected from boron, phosphorus, carbon, aluminium, calcium, iron, nickel, titanium and zinc and/or hydrogen.

The profile of these contaminants of the ultrahigh-purity product is as follows:

a. aluminium less than or equal to 5 ppm by weight or from 5 ppm by weight to 0.0001 ppt by weight, preferably from 3 ppm by weight to 0.0001 ppt by weight, and/or

b. boron from 10 ppm by weight to 0.0001 ppt by weight, preferably in the range from 5 to 0.0001 ppt by weight, further preferably in the range from 3 ppm by weight to 0.0001 ppt by weight, and/or

c. calcium less than or equal to 2 ppm by weight, preferably from 2 ppm by weight to 0.0001 ppt by weight, and/or

d. iron less than or equal to 20 ppm by weight, preferably from 10 ppm by weight to 0.0001 ppt by weight, further preferably from 0.6 ppm by weight to 0.0001 ppt by weight, and/or

e. nickel less than or equal to 10 ppm by weight, preferably from 5 ppm by weight to 0.0001 ppt by weight, further preferably from 0.5 ppm by weight to 0.0001 ppt by weight, and/or

f. phosphorus less than 10 ppm by weight to 0.0001 ppt by weight, preferably from 5 ppm by weight to 0.0001 ppt by weight, further preferably from 3 ppm by weight to 0.0001 ppt by weight, and/or

g. titanium less than or equal to 10 ppm by weight, less than or equal to 2 ppm by weight, preferably from 1 ppm by weight to 0.0001 ppt by weight, further preferably from 0.6 ppm by weight to 0.0001 ppt by weight, further preferably from 0.1 ppm by weight to 0.0001 ppt by weight, and/or

h. zinc less than or equal to 3 ppm by weight, preferably from 1 ppm by weight to 0.0001 ppt by weight, further preferably from 0.3 ppm by weight to 0.0001 ppt by weight,

i. carbon, and

j. hydrogen,
where the target content of hydrogen and carbon is in each case in a concentration in the region of the detection limit of the measurement method known to the person skilled in the art.

The total contamination of the product with the aforementioned elements or contaminants is in the range from 100 ppm by weight to 0.001 ppt by weight in the high-purity product and preferably from 50 ppm by weight to 0.001 ppt by weight in the ultrahigh-purity product in total. The product obtained according to the invention has a concentration of hydrogen in the range of the detection limit of the measurement method known to the person skilled in the art.

In the method, a gas discharge reactor with two columns can be used for generating a nonthermal plasma. According to the process, the nonthermal plasma is preferably an electrically generated plasma. This is generated in a plasma reactor in which a plasma-electric conversion is induced and is based on anisothermal plasmas. For these plasmas, a high electron temperature Tₑ≧10⁴ K and relatively low gas temperature T_{G}≦10³ K are characteristic. The activation energy required for the chemical processes takes place predominantly via electron collisions (plasma-electric conversion). Typical nonthermal plasmas can be generated, for example, by glow discharge, HF discharge, hollow cathode discharge or corona discharge. The operating pressure at which the plasma treatment according to the invention is carried out is preferably 1 to 1000 mbar_{abs}, particularly preferably 100 to 500 mbar_{abs}, in particular 200 to 500 mbar_{abs}, where the phase to be treated is adjusted preferably to a temperature of −40° C. to 200° C., particularly preferably to 20 to 80° C., very particularly preferably to 30 to 70° C.

In the case of germanium compounds, the corresponding temperature can differ from this—be higher or lower.

For the definition of the nonthermal plasma, reference is made to the relevant specialist literature, such as for example to “Plasmatechnik: Grundlagen and Anwendungen—Eine Einführung [Plasma Technology: Fundamentals and Applications—An Introduction]; team of authors”, Carl Hanser Verlag, Munich/Vienna; 1984, ISBN 3-446-93627-4.

Paschen's law states that the starting voltage for the plasma discharge is essentially a function of the product p•d, from the pressure of the gas, p, and the electrode distance, d. For the process according to the invention, this product is in the range from 0.001 to 300 mm•bar, preferably from 0.01 to 100 mm•bar, particularly preferably 0.05 to 10 mm•bar, in particular 0.07 to 2 mm•bar. The discharge can be induced by means of various AC voltages and/or pulsed voltages from 1 to 1000 kV. The magnitude of the voltage depends, in a manner known to the person skilled in the art, not only on the p•d value of the discharge arrangement but also on the process gas itself. Particularly suitable are those pulsed voltages which permit high edge slopes and a simultaneous formation of the discharge within the entire discharge space of the reactor.

The distribution over time of the AC voltage and/or of the coupled electromagnetic pulse can be rectangular, trapezoid, pulsed or composed in sections of individual time distributions. AC voltage and coupled electromagnetic pulse can be combined in each of these forms of the time distribution.

In the process of the invention, the AC voltage frequency f may be within a range from 1 Hz to 100 GHz, preferably from 1 Hz to 100 MHz. The repetition rate g of the electromagnetic pulse superimposed on this base frequency may be selected within a range from 0.1 kHz to 50 MHz, preferably from 50 kHz to 50 MHz. The amplitude of these pulses may be selected from 1 to 15 kVₚₚ (kV peak to peak), preferably from 1 to 10 kVₚₚ, more preferably from 1 to 8 kVₚₚ.

These pulses can have all shapes known to the person skilled in the art, e.g. sine, rectangle, triangle, or a combination thereof. Particularly preferred shapes are rectangle or triangle.

This in itself increases the yield, based on the time, of high-purity or ultrahigh-purity product considerably compared to the process of the prior art without coupled electromagnetic pulse and a sinusoidal distribution of the AC voltage producing the plasma.

A further increase in the yield can be attained if, in the process according to the invention, the electromagnetic pulse coupled into the plasma is superimposed with at least one further electromagnetic pulse with the same repetition rate, or the two or at least two pulses are in a duty ratio of 1 to 1000 relative to one another. Preferably, both pulses are selected with a rectangular shape, in each case with a duty ratio of 10 and a very high edge slope. The greater the edge slope, the higher the yield. The amplitude selected for these pulses may be from 1 to 15 kVₚₚ, preferably from 1 to 10 kVₚₚ.

The yield increases with the repetition rate. For example, in the case of repetition rates with the multiple base frequency, for example the 10-fold base frequency, a saturation effect can be found in which a further increase in the yield is no longer produced. This saturation effect can depend on the gas composition, the p·d value of the experimental arrangement, but also on the electric adaptation of the plasma reactor to the electronic ballast.

In the process of the invention, the electromagnetic pulse or pulses can be coupled through a pulse ballast with current or voltage impression. If the pulse is current-impressed, a greater edge slope is obtained.

In a further embodiment of the process according to the invention, the pulse can also be coupled in a transient asynchronous manner known to the person skilled in the art instead of a periodic synchronous manner.

The resulting phase obtained after step a of the process according to the invention is subjected, in step b, at least once, preferably once, to a vacuum rectification and filtration.

Preferably, in step b a vacuum fine distillation can be carried out which separates off the higher molecular weight polychlorosilanes or germanium compounds. Alternatively or additionally, a chromatographic work-up can also follow in order to separate off contaminants or else in order to adjust the content of silicon compounds of the general formula Si₃X₈ or Si₄X₁₀ or germanium compounds of the general formula Ge₃X₈ or Ge₄X₁₀.

It can also be advantageous to carry out process steps a and/or b continuously.

The invention likewise provides an apparatus for continuously carrying out the process according to the invention, which apparatus is characterized in that it has a reactor for generating the nonthermal plasma, and at least one vacuum rectification column, and at least one filtration device, and/or adsorption device.

The apparatus according to the invention can have an ozonizator as reactor. Preferably, the reactor can be equipped with glass tubes, in particular with quartz glass tubes. The glass tubes of the apparatus can be kept at a distance by means of spacers made of inert material. Such spacers can advantageously be made of glass or Teflon.

The invention also provides the use of the silicon compound or germanium compound prepared according to the invention for producing silicon nitride, silicon oxynitride, silicon carbide, silicon oxycarbide or silicon oxide, or germanium nitride, germanium oxynitride, germanium carbide, germanium oxycarbide or germanium oxide.

Preferably, the product obtained according to the invention is used for producing layers of silicon nitride, silicon oxynitride, silicon carbide, silicon oxycarbide or silicon oxide, or layers of germanium nitride, germanium oxynitride, germanium carbide, germanium oxycarbide or germanium oxide.

The process according to the invention will be illustrated below by reference to examples.

### EXAMPLE 1 (ISOLATION OF OCTACHLOROTRISILANE)

In a rectification plant, 1212 g of silane mixture, which comprised tri- and oligosilanes, were introduced into the rectification pot under nitrogen atmosphere as protective gas.

The apparatus was then evacuated to 8 mbar and heated to 157° C. 269 g of octachlorotrisilane were obtained.

The octachlorotrisilane obtained as the result of the column distillation was filtered over a 0.45 μm polypropylene filter under protective gas and high-purity octachlorotrisilane was obtained in this way in a gentle manner.

### EXAMPLE 2 (ISOLATION OF OCTACHLOROTRISILANE)

In a rectification plant, 300 kg of silane mixture, comprising tri- and oligosilanes, were introduced into the rectification pot under protective-gas conditions (nitrogen atmosphere).

The rectification unit, packed with a stainless steel distillation packaging has between 80 and 120 theoretical plates.

The apparatus was evacuated to 9.3 mbar and heated to 170° C. 121.6 kg of octachlorotrisilane with a purity, measured by gas chromatography, of more than 95% were obtained.

The octachlorotrisilane obtained as the result of the column distillation was then filtered over a 0.45 pm polypropylene filter under protective gas. High-purity octachlorotrisilane was obtained in this way.

### EXAMPLE 3 (ISOLATION OF DECACHLOROTETRASILANE)

In a rectification plant, 468 g of silane mixture, comprising oligosilanes, was introduced into the rectification pot under a nitrogen atmosphere as protective gas. The apparatus was then evacuated to 2 mbar and heated to 157° C. 160 g of decachlorotetrasilane were obtained.

The decachlorotetrasilane obtained as the result of the column distillation was filtered over a 0.45 μm polypropylene filter under protective gas and high-purity decachlorotetrasilane was obtained in this way in a gentle manner. cl EXAMPLE 4 (ISOLATION OF DECACHLOROTETRASILANE)

In a rectification plant, 300 kg of silane mixture, comprising tri- and oligosilanes, were introduced into the rectification pot under protective-gas conditions (nitrogen atmosphere).

The rectification unit, packed with a stainless steel distillation packing, had between 80 and 120 theoretical plates.

After separating the octachlorotrisilane, as described in Example 2, the apparatus was evacuated to 3.33 mbar and heated to 184° C. 39.6 kg of decachlorotetrasilane with a purity, determined by gas chromatography, of more than 95% were obtained.

The decachlorotetrasilane obtained as the result of the column distillation was filtered over a 0.45 μm polypropylene filter under protective gas and in this way high-purity decachlorotetrasilane was obtained in a gentle manner.

1. A process for the preparation of at least one compound selected from the group consisting of trimeric and quaternary silicon compounds of the general formula Si₃X₈, Si₄X₁₀, or both
or of at least one compound selected from the group consisting of trimeric and/or and quaternary germanium compounds of the general formula Ge₃X₈, and/or Ge₄X₁₀, or both, the process comprising:
a) exposing a mixture of silicon compounds of the general formula
Siₙ(R₁ . . . R₂ₙ₊₂)
or a mixture of germanium compounds of the general formula
Geₙ(R₁ . . . R₂ₙ₊₂)
to a nonthermal plasma to form a resulting phase
wherein n≧2, and R₁ to R₂ₙ₊₂ is at least one element selected from the group consisting of hydrogen and X
wherein X
is at least one halogen selected from the group consisting of chlorine, bromine, and iodine, and
b) subjecting the resulting phase at least once to a vacuum rectification and filtration, thereby obtaining
silicon compounds of the general formula Si₃X₈ or Si₄X₁₀
or germanium compounds of the general formula Ge₃X₈ or Ge₄X_{10.}

2. The process according to claim 1, wherein with n≧3.

3. The process according to claim 1, further comprising subjecting the resulting phase to an adsorption, after or before the subjecting to a vacuum rectification and filtration b.

4. The process according to claim 1,
wherein
the process exposing to a nonthermal plasma a), the process subjecting to a vacuum rectification and filtration b), or both take place continuously.

5. The process according to claim 1,
wherein
the exposing to a nonthermal plasma treatment in process a) takes place at pressures from 1 to 1000 mbar_{abs}.

6. An apparatus configured for continuously carrying out the process
according to claim 1, the apparatus comprising:
a reactor suitable for generating the nonthermal plasma, and
at least one vacuum rectification column, and
at least one filtration apparatus, adsorption apparatus, or both.

7. The apparatus according to claim 6,
wherein
the reactor is an ozonizator.

8. The apparatus according to claim 6,
wherein
the reactor is equipped with glass tubes.

9. The apparatus according to claim 8,
wherein
the glass tubes in the reactor are kept at a distance by a spacer comprising an inert material.

10. The apparatus according to claim 9,
wherein
the inert material of the spacer is glass or Teflon.

11. A method, comprising: producing silicon nitride, silicon oxynitride, silicon carbide, silicon oxycarbide or silicon oxide, or
germanium nitride, germanium oxynitride, germanium carbide, germanium oxycarbide or germanium oxide
from the silicon compounds or the germanium compounds produced according to claim 1.

12. The method according to claim 11 comprising producing the silicon nitride, silicon oxynitride, silicon carbide, silicon oxycarbide or silicon oxide, or of the germanium nitride, germanium oxynitride, germanium carbide, germanium oxycarbide or germanium oxide in the form of layers.

13. The apparatus according to claim 8, wherein the glass tubes are quartz glass tubes.

14. The process according to claim 1, wherein the silicon compounds of the general formula Si₃X₈ or Si₄X₁₀ or the germanium compounds of the general formula Ge₃X₈ or Ge₄X₁₀ have a content of hydrogen atoms below 1×10⁻³% by weight relative to the total weight of the compounds.

15. The process according to claim 1, wherein the silicon compounds of the general formula Si₃X₈ or Si₄X₁₀ or the germanium compounds of the general formula Ge₃X₈ or Ge₄X₁₀ have a total contamination content of less than or equal to 100 ppm by weight relative to the total weight of the compounds.

16. The process according to claim 15, wherein the total contamination content comprises at least one contaminant selected from the group consisting of aluminum, boron, calcium, iron, nickel, phosphorous, titanium, zinc, carbon, and hydrogen.

17. The process according to claim 1, wherein the silicon compounds of the general formula Si₃X₈ or Si₄X₁₀ or the germanium compounds of the general formula Ge₃X₈ or Ge₄X₁₀ are at least one compound selected from the group consisting of decachlorotetrasilane and decachlorotetragermane.

18. The process according to claim 1, wherein the nonthermal plasma is an electrically generated plasma.

19. A process for the preparation of quaternary silicon compounds of the general formula Si₄X₁₀ or of quaternary germanium compounds of the general formula Ge₄X₁₀, the process comprising:
a) exposing a mixture of silicon compounds of the general formula
Siₙ(R₁ . . . R₂ₙ₊₂)
or a mixture of germanium compounds of the general formula
Geₙ(R₁ . . . R₂ₙ₊₂)
to a nonthermal plasma to form a resulting phase
wherein n≧2, and R₁ to R₂ₙ₊₂ is at least one element selected from the group consisting of hydrogen and X
wherein X is at least one halogen selected from the group consisting of chlorine, bromine, and iodine, and
b) subjecting the resulting phase at least once to a vacuum rectification and filtration, thereby obtaining
silicon compounds of the general formula Si₄X₁₀
or germanium compounds of the general formula Ge₄X_{10.}

20. The process according to claim 19, wherein n≧3.
